(19) United States
(12) Patent Application Publication
(10) Pub. No.: US 2011/0089828 A1
(43) Pub. Date: Apr. 21, 2011

(54) METAL HALIDE LAMP, AND LIGHTING EQUIPMENT EMPLOYING METAL LAMP

(76) Inventors: Yukiya Kanazawa, Osaka (JP); Shunsuke Kakisaka, Osaka (JP)

(21) Appl. No.: 12/934,611

(22) PCT Filed: Mar. 26, 2009
(86) PCT No.: PCT/JP2009/001365

§ 371 Date: Dec. 8, 2010

(30) Foreign Application Priority Data
Mar. 27, 2008 (JP) 2008-082819

(51) Int. Cl. H01J 61/18

(52) U.S. Cl. 313/638

(57) ABSTRACT

Provided is a metal halide lamp that can (i) prevent flicker in an illuminated surface of an arc tube, which is caused by violent movement of an electric arc when the lamp is lit while being tilted, (ii) suppress an early reduction in a luminous flux maintenance factor, and (iii) suppress formation of cracks in an enclosure of the arc tube. The lamp comprises (i) an arc tube 3 that (a) is arranged inside an outer tube 2, (b) has at least one selected from the group consisting of Ce and Pr enclosed therein as a light emitting material, and (c) is made of translucent ceramic, and (ii) a sleeve 4 arranged outside the arc tube 3, so as to surround a part of a discharge space 13 in the arc tube 3 extending between a pair of electrodes 12. The relationship 0.7<L/D<3 is satisfied in the lamp, with L denoting the inter-electrode distance [mm] and D denoting a largest inner diameter [mm] of a part of the arc tube 3 surrounding the part of the discharge space 13. The relationship R/r≦−0.0019P+2.625 (R/r>1) is also satisfied in the lamp, with R denoting an average inner diameter [mm] of a part of the sleeve 4 surrounding the part of the discharge space 13, r denoting an average outer diameter [mm] of the part of arc tube 3, and P denoting a power rating [W] of the lamp.

### TECHNICAL FIELD

The present invention relates to a metal halide lamp and to a lighting device using the metal halide lamp.

### BACKGROUND ART

Due to the recent trend toward energy conservation, there has been a strong demand for improvement in the luminous efficacy of a metal halide lamp used for outdoor lights, high-ceiling lights, etc.

One proposal that has been made to improve the luminous efficacy of a metal halide lamp is to enclose a halide compound containing cerium and/or praseodymium, each of which has a low vapor pressure but has high luminous efficacy, in the lamp as a light emitting material. In view of this, it has been suggested that an arc tube of a metal halide lamp (i) include an enclosure made of translucent ceramic that contains alumina etc. and thus resist a high tube wall loading, i.e., a high temperature, (ii) have cerium iodide (CeI₃) and sodium iodide (NaI) enclosed therein, and (iii) have a high tube wall loading (for example, see Patent Literature 1).

Patent Literature 1 discloses that high luminous efficacy can be achieved by increasing vapor pressures of cerium iodide and sodium iodide while heightening the tube wall loading of an arc tube. Note, provided that a distance between a pair of electrodes arranged in the arc tube is L and a largest inner diameter of a part of the arc tube surrounding a space extending between the electrodes is D, the arc tube disclosed in Patent Literature 1 has a large diameter with respect to L, and satisfies the relationship L/D<3.

Another proposal that has been made to improve the luminous efficacy of a metal halide lamp is to, instead of using a halide compound containing cerium and/or praseodymium, provide a shroud (sleeve) that surrounds an arc tube such that the dimensional rate of the largest outer diameter of the arc tube to an inner diameter of the shroud falls within a predetermined range. This structure can raise the temperature of the arc tube and therefore raise the vapor pressure of a light emitting material (for example, see Patent Literature 2).

Patent Literature 2 discloses that, as the shroud shields the thermal radiation emitted from the arc tube, the shroud can suppress the heat release from the arc tube and thus retain the heat of the arc tube, which results in increase in the vapor pressure of the light emitting material and improvement in the luminous efficacy.

### CITATION LIST

### Patent Literature

### Patent Literature 1

Japanese Patent Application Publication No. 2003-086130

### Patent Literature 2

Japanese Patent Application Publication No. 2003-100253

### SUMMARY OF INVENTION

### Technical Problems

Both cerium and praseodymium are metals with low vapor pressures. Therefore, when cerium and/or praseodymium are enclosed as a light emitting material as with the metal halide lamp disclosed in Patent Literature 1, in order to achieve high luminous efficacy, it is required to raise the operating temperature of the arc tube by, for example, sufficiently increasing the tube wall loading of the arc tube so as to maintain constant vapor pressures.

Note that “the operating temperature of the arc tube” means the temperature of an inner space of the arc tube while the lamp is being lit.

However, studies conducted by the inventors of the present invention (hereinafter, simply “the inventors”) have revealed the following new problem that had never been seen before. In order to raise the operating temperature of an arc tube, the inventors increased the tube wall loading of the arc tube by reducing the size of the arc tube. As a result, the illuminated surface of the arc tube “flickered” due to violent movement of an electric arc when the lamp was lit while being tilted, as compared to when the lamp was lit while standing vertically with a base of the lamp being located in the uppermost position. Although enclosing cerium and/or praseodymium as a light emitting material already made the electric arc thin, the electric arc was further thinned by increasing the tube wall loading. This increased the difference between (i) the temperature of a radially central area of the space within the arc tube, and (ii) the temperature of a circumferential area of the space within the arc tube that was in the vicinity of the tube wall and located more outward in the radial direction than the radially central area was. It is assumed that the above phenomena activated the convection of a gas that filled the arc tube, promoting the violent movement of the electric arc. The “flicker” problem was prominent especially when the mole fraction of cerium and/or praseodymium in the light emitting material was large. Note that the light emitting material used by the inventors was a combination of (i) a halide compound containing cerium and/or praseodymium and (ii) a halide compound containing sodium.

The inventors also studied metal halide lamps in which a halide compound containing dysprosium (Dy) and sodium and a halide compound containing thulium (Tm) and sodium were respectively enclosed as light emitting materials, instead of a halide compound containing cerium and/or praseodymium. The inventors confirmed neither violent movement of the electric arcs nor flicker in the illuminated surfaces of the arc tubes in such lamps, regardless of the mole fractions of dysprosium, sodium and thulium in the respective light emitting materials. This indicates that the problem of “flicker” in the illuminated surface of an arc tube occurs when cerium and/or praseodymium are enclosed as a light emitting material.

In order to raise the operating temperature of an arc tube without increasing the tube wall loading, a sleeve may be provided surrounding the arc tube, as disclosed in Patent Literature 2. However, if the sleeve is used only for the purpose of keeping the dimensional rate between the largest outer diameter of the arc tube and an inner diameter of the sleeve within a predetermined range without any consideration for the power rating of the lamp, then there may be cases where an appropriate operating temperature of the arc tube cannot be maintained. In such cases, the aforementioned “flicker” problem occurs.

Such a lamp having the “flicker” problem also suffers from the following problems: the luminous flux maintenance factor of the lamp is significantly reduced, with the result that its lamp life comes to an end after only 3000 hours of lighting, as opposed to a rated lamp life of e.g. 18000 hours. Note that the phrase “after . . . hours of lighting” has the same meaning as “when . . . hours of lighting have elapsed”. Also note that “its lamp life . . . comes to an end . . . ” means that the luminous flux maintenance factor of the lamp becomes less than 80[%] after 3000 hours of lighting. Also note that “the luminous flux maintenance factor” means the rate of luminous flux of the lamp measured after 3000 hours of lighting to luminous flux of the lamp measured after 100 hours of lighting, with the latter luminous flux considered to be 100[%].

It has been found that the above problems are attributed to an abnormal local temperature increase in the arc tube. The abnormal local temperature increase in the arc tube occurs because (i) the electric arc is displaced instantaneously and repeatedly due to the aforementioned violent movement of the electric arc, and (ii) between a pair of electrodes arranged in the arc tube, the displacement of the electric arc is not only inconsistent but also large in extent. It is assumed that the luminous flux maintenance factor of the lamp is reduced because the extremely thin and high-temperature electric arc changes the crystal structure of a ceramic, such as alumina, constituting the enclosure of the arc tube, promoting evaporation thereof and causing scattered alumina particles to attach to the inner surface of the sleeve.

The lamp having the above “flicker” problem also gives rise to the problem that cracks form in the enclosure (ceramic) of the arc tube, especially when the lamp is lit while being tilted. As described above, the temperature distribution in the arc tube shows an abnormal temperature increase in a part of the arc tube because (i) the electric arc is displaced instantaneously and repeatedly due to the aforementioned violent movement of the electric arc, and (ii) between the pair of electrodes arranged in the arc tube, the displacement of the electric arc is not only inconsistent but also large in extent. The unevenness of the temperature distribution in the arc tube grows, increasing the thermal stress applied to the enclosure. It is assumed that the increase in the thermal stress causes the cracks to form.

The present invention has been made to solve the above-described problems. The present invention aims to provide a metal halide lamp that achieves the following effects in a case where at least one selected from the group consisting of cerium and praseodymium is enclosed in the metal halide lamp as a light emitting material: (i) preventing flicker in the illuminated surface of an arc tube, which is caused by violent movement of an electric arc especially when the lamp is lit while being tilted; (ii) suppressing an early reduction in the luminous flux maintenance factor, which is caused by scattering of materials constituting an enclosure of the arc tube; and (iii) suppressing formation of cracks in the enclosure of the arc tube. The present invention also aims to provide a lighting device using the above metal halide lamp.

### Solution to Problems

In order to improve the luminous efficacy, a conventional ceramic metal halide lamp is intended to operate while being subjected to a high tube wall loading. The tube wall loading of an arc tube in the conventional ceramic metal halide lamp is set even higher especially when cerium and/or praseodymium, which have low vapor pressures, are enclosed in the lamp as a light emitting material. However, after conducting diligent studies to solve the above-described problems, the inventors have found that (i) the operating temperature of an arc tube pertaining to the present invention can be raised to yield high luminous efficacy from cerium and praseodymium, without making the tube wall loading of the arc tube higher than that of the conventional arc tube, and (ii) consequently, the above-described various problems can be solved. Note, “without making the tube wall loading of the arc tube higher than that of the conventional arc tube” means that the tube wall loading of the arc tube pertaining to the present invention can be lower than that of the conventional arc tube.

A metal halide lamp of the present invention is comprises: an outer tube; an arc tube that is arranged inside the outer tube and includes (i) an enclosure made of translucent ceramic and (ii) a pair of electrodes arranged inside the enclosure; and a sleeve that is arranged inside the outer tube and outside the arc tube so as to surround at least a part of a discharge space in the arc tube, the part of the discharge space extending between the pair of electrodes. In the metal halide lamp, (i) a light emitting material that includes at least one selected from the group consisting of cerium (Ce) and praseodymium (Pr) is enclosed in the enclosure, (ii) a relationship 0.7<L/D<3 is satisfied, with L denoting a distance [mm] between the electrodes and D denoting a largest inner diameter [mm] of a part of the arc tube surrounding the part of the discharge space, and (iii) a relationship R/r≦−0.0019P+2.625 is satisfied (where R/r>1), with R denoting an average inner diameter [mm] of a part of the sleeve surrounding the part of the discharge space, r denoting an average outer diameter [mm] of the part of the arc tube, and P denoting a lamp power rating [W].

Note that in the present invention, “a part of a discharge space in the arc tube, the part of the discharge space extending between the pair of electrodes” denotes a part of the discharge space extending between (i) a first plane that (a) passes through a tip of one of the electrodes that faces the other electrode and (b) is perpendicular to the direction in which the electrodes lie, and (ii) a second plane that (a) passes through a tip of the other electrode that faces said one of the electrodes and (b) is parallel to the first plane. Similarly, “a part of the arc tube surrounding the part of the discharge space” and “a part of the sleeve surrounding the part of the discharge space” respectively denote parts of the arc tube and the sleeve that extend between the first and second planes.

Also, in the present invention, “R/r”, which is the rate of (i) the average inner diameter R of the part of the sleeve surrounding the part of the discharge space to (ii) the average outer diameter r of the part of the arc tube surrounding the part of the discharge space, is referred to as a dimensional rate of an inner diameter of the sleeve to an outer diameter of the arc tube, or simply referred to as a dimensional rate.

Also, in the present invention, the arc tube satisfies the relationship “0.7<L/D<3”, with L/D denoting the rate of the inter-electrode distance L to the largest inner diameter D of the arc tube.

A lighting device of the present invention comprises: a housing to which a lamp socket is joined; the above-described metal halide lamp, which is attached to the lamp socket; and a ballast for lighting the metal halide lamp.

### ADVANTAGEOUS EFFECTS OF INVENTION

In the metal halide lamp of the present invention, the sleeve surrounding the arc tube can suppress the heat release from the arc tube and therefore can retain the heat of the arc tube. Furthermore, because the dimensional rate (R/r) of the inner diameter of the sleeve to the outer diameter of the arc tube is determined in accordance with the power rating of the lamp, the present invention can efficiently increase the sleeve's effect of retaining the heat of the arc tube. Furthermore, as the sleeve retains the heat of the arc tube while surrounding the arc tube, it is possible to suppress reduction in the temperature of the space within the arc tube in the vicinity of the tube wall of the arc tube. This reduces the difference between (i) the temperature of a radially central area of the space within the arc tube, and (ii) the temperature of a circumferential area of the space within the arc tube that is in the vicinity of the tube wall of the arc tube. By thus reducing such a temperature difference in the arc tube, activation of the convection of a gas that fills the arc tube can be suppressed. This makes it possible to suppress violent movement of the electric arc when the lamp is lit while being tilted.

As set forth above, the metal halide lamp of the present invention and the lighting device using the same can (i) prevent flicker in the illuminated surface of the arc tube, which is caused by violent movement of the electric arc especially when the lamp is lit while being tilted, (ii) suppress an early reduction in the luminous maintenance factor, which is caused by scattering of materials constituting the enclosure of the arc tube, and (iii) suppress formation of cracks in the enclosure of the arc tube.

### BRIEF DESCRIPTION OF DRAWINGS

FIG. 1 is a partially cut-away front view of a metal halide lamp, which is the first embodiment of the present invention.

FIG. 2 is a cross-sectional front view of an arc tube included in the metal halide lamp.

FIG. 3 shows changes in the luminous flux maintenance factors of metal halide lamps having a power rating of 250 [W] in relation to elapsed time of lighting.

FIG. 4 shows changes in the total luminous fluxes of metal halide lamps having a power rating of 250 [W] in relation to R/r.

FIG. 5 shows changes in the general color rendering indexes [Ra] of metal halide lamps having a power rating of 250 [W] in relation to R/r.

FIG. 6 shows changes in the total luminous fluxes of metal halide lamps having a power rating of 250 [W] in relation to the mole fraction of cerium enclosed.

FIG. 7 shows changes in the general color rendering indexes [Ra] of metal halide lamps having a power rating of 250 [W] in relation to the mole fraction of cerium enclosed.

FIG. 8 shows changes in the luminous flux maintenance factors of metal halide lamps having a power rating of 400 [W] in relation to elapsed time of lighting.

FIG. 9 shows changes in the total luminous fluxes of metal halide lamps having a power rating of 400 [W] in relation to R/r.

FIG. 10 shows changes in the general color rendering indexes [Ra] of metal halide lamps having a power rating of 400 [W] in relation to R/r.

FIG. 11 shows changes in the total luminous fluxes of metal halide lamps having a power rating of 400 [W] in relation to the mole fraction of cerium enclosed.

FIG. 12 shows changes in the general color rendering indexes [Ra] of metal halide lamps having a power rating of 400 [W] in relation to the mole fraction of cerium enclosed.

FIGS. 13A and 13B show changes in the luminous flux maintenance factors of metal halide lamps having a power rating of 180 [W] in relation to elapsed time of lighting.

FIG. 14 shows changes in the total luminous fluxes of metal halide lamps having a power rating of 180 [W] in relation to R/r.

FIG. 15 shows changes in the general color rendering indexes [Ra] of metal halide lamps having a power rating of 180 [W] in relation to R/r.

FIG. 16 shows changes in the luminous fluxes of metal halide lamps having a power rating of 180 [W] in relation to the mole fraction of cerium enclosed.

FIG. 17 shows changes in the general color rendering indexes [Ra] of metal halide lamps having a power rating of 180 [W] in relation to the mole fraction of cerium enclosed.

FIG. 18 shows a relationship between the power rating P and the dimensional rate R/r.

FIG. 19 is a partial cut-away front view of a lighting device, which is the second embodiment of the present invention.

### DESCRIPTION OF EMBODIMENTS

Embodiments of the present invention are described below with reference to the drawings.

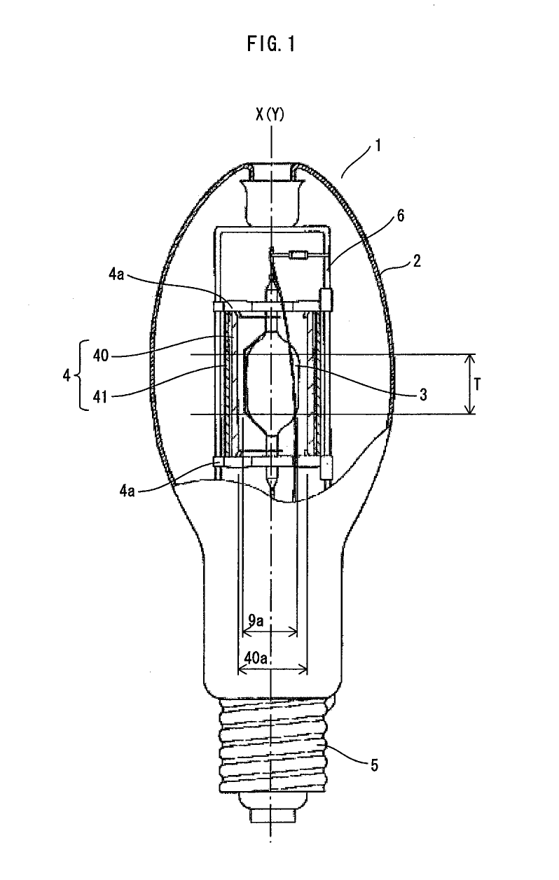

Described below is the first embodiment of the present invention. The first embodiment introduces metal halide lamps that each have a power rating of 180 [W], 250 [W] or 400 [W]. These metal halide lamps having different power ratings share the same fundamental structure. For simplicity, the present embodiment explains the shared fundamental structure of the metal halide lamps with reference to a metal halide lamp 1 shown in FIG. 1.

Each of the metal halide lamps (ceramic metal halide lamps) 1 of the first embodiment has a power rating of 180 [W], 250 [W] or 400 [W]. As shown in FIG. 1, each of the metal halide lamps 1 is composed of (i) an outer tube 2, (ii) an arc tube 3 arranged inside the outer tube 2, (iii) a sleeve 4 arranged between the outer tube 2 and the arc tube 3 so as to surround the arc tube 3, and (iv) an Edison screw base 5 attached to one end of the outer tube 2.

The outer tube 2 is a B-type bulb (its central circumference in a longitudinal direction bulges) made of hard glass, borosilicate glass, or the like. A stem (not illustrated) is sealed in the inner space of the outer tube 2 at one end of the outer tube 2 near the base 5. A frame 6 is attached to the stem to support the arc tube 3 and the sleeve 4. The frame 6 is formed by processing a metal wire or the like. Two stem wires (not illustrated) that are electrically connected to the base 5 are joined to the stem. At a temperature of 300 [K], the inside of the outer tube 2 is either (i) vacuum, with an inner pressure of 1×10¹ [Pa] or lower (e.g., 1×10⁻¹ [Pa]) or (ii) a nitrogen atmosphere having an inner pressure of 40 [kPa] to 80 [kPa].

Note that the outer tube 2 is not limited to having the B-type shape, but may have any of various known shapes.

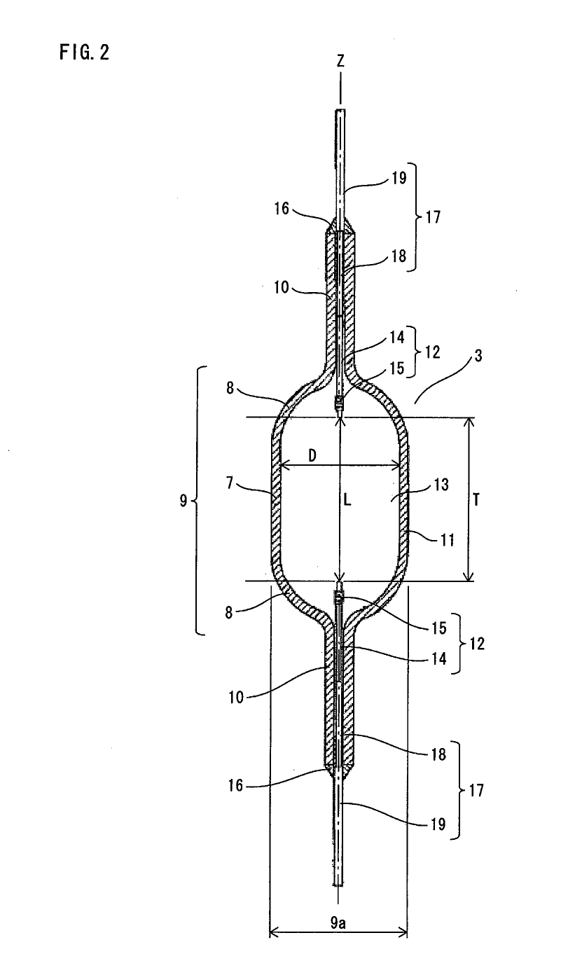

As shown in FIG. 2, the arc tube 3 includes an enclosure 11 made of, for example, polycrystalline alumina. The enclosure 11 is composed of a main tube portion 9 and narrow tube portions 10. The main tube portion 9 includes a cylindrical portion 7 and hemispherical portions 8 that are connected to respective ends of the cylindrical portion 7. The narrow tube portions 10 are respectively connected to the hemispherical portions 8.

Referring to the example shown in FIG. 2, the portions that make up the enclosure 11 of the arc tube 3 are a single integrated component as a whole; in other words, there is no joint in the enclosure 11. Alternatively, the enclosure 11 may be constructed in the following manner: after preparing the main tube portion and the narrow tube portions separately, the narrow tube portions are respectively shrink-fitted to the hemispherical portions of the main tube portion. Although it has been described above with reference to the example shown in FIG. 2 that the main tube portion 9 of the arc tube 3 includes the cylindrical portion 7 and the hemispherical portions 8 that are connected to respective ends of the cylindrical portion 7, the main tube portion 9 is not limited to such a configuration. The same functional effects as those described below can be obtained also when the main tube portion 9 has any other known shape (e.g., a substantially spheroidal shape) or any applicable shape that can be ordinarily thought of. It goes without saying that the same functional effects as those described below can be obtained also when the arc tube 3 itself has any other known shape or any applicable shape that can be ordinarily thought of. Furthermore, the enclosure 11 of the arc tube 3 is not limited to being made of polycrystalline alumina, but may be made of translucent ceramic such as yttrium aluminum garnet (YAG), aluminum nitride, yttrium oxide, and zirconium dioxide.

A pair of electrodes 12 are arranged inside the main tube portion 9 of the arc tube 3, substantially coaxially with each other (on axis Z shown in FIG. 2) and substantially facing each other. The main tube portion 9 has a discharge space 13 therein. Each electrode 12 includes (i) an electrode bar 14 made of tungsten and (ii) an electrode coil 15 made of tungsten and attached to one end of the electrode bar 14. Outer ends of the electrodes 12 are electrically connected to electrode inductors 17, respectively. The electrode inductors 17 have been (i) inserted into the narrow tube portions 10, and (ii) sealed by glass frits 16 that have been poured only into ends of the narrow tube portions 10 that are farthest from the main tube portion 9.

Each electrode inductor 17 includes (i) an inner lead wire 18 that is made of, for example, molybdenum and connected to the corresponding electrode bar 14, and (ii) an outer lead wire 19 that is made of, for example, niobium. Ends of the outer lead wires 19 that are on the opposite sides of the internal lead wires 18 are electrically connected to the stem wires via conductive members (not illustrated) outside the narrow tube portions 10, respectively. Within the outer tube 2, the arc tube 3 is supported not only by the above-mentioned frame 6, but also via the stem wires and the conductive members.

The electrode inductors 17, each of which includes the internal lead wire 18 made of molybdenum and the outer lead wire 19 made of niobium, may be replaced with other electrode inductors made of known materials and having a known structure.

Provided that a distance between the pair of electrodes 12 (hereinafter referred to as “inter-electrode distance”, see FIG. 2) is L [mm] and that a largest inner diameter of a part of the arc tube 3 surrounding a part of the discharge space 12 extending between the pair of electrodes 12 (i.e., a range denoted by T in FIG. 2) is D [mm], the arc tube 3 has a large diameter with respect to L, and satisfies the relationship 0.7<L/D<3. As with FIG. 2, a range denoted by T in FIG. 1 shows parts of the arc tube 3 and the sleeve 4 surrounding the part of the discharge space 12 extending between the pair of electrodes 12.

At least one selected from the group consisting of cerium (Ce) and praseodymium (Pr) is enclosed in the arc tube 3 as a light emitting material. Note that the light emitting material is enclosed in the arc tube 3 in the form of a halide compound, such as cerium iodide (CeI₃), cerium bromide (CeBr₃), praseodymium iodide (PrI₃), and praseodymium bromide (PrBr₃). In addition to this light emitting material, various types of light emitting metals are also enclosed in the arc tube 3 as light emitting materials, such as sodium (Na), dysprosium (Dy), scandium (Sc), thulium (Tm) and calcium (Ca), according to desired color characteristics and the like. Furthermore, in addition to the above light emitting materials, predetermined amounts of mercury (Hg) and noble gases (an argon (Ar) gas, a krypton (Kr) gas, etc.) are also enclosed in the arc tube 3 as a buffer gas and starter assistant gasses, respectively.

Note, when the dimensional rate R/r (described later) satisfies the relationship −0.0019P+1.79≦R/r, the mole fraction of a sum of cerium and praseodymium in the total amount of light emitting materials enclosed (excluding mercury) is preferably 11.8 [mol %] or more. The reason for this will be described later.

Turning to FIG. 1, the sleeve 4 has a double-layer structure and includes (i) a first sleeve portion 40 (the inner side) directly surrounding the arc tube 3, and (ii) a second sleeve portion 41 (the outer side) surrounding the first sleeve portion 40 with a small space therebetween. Each of the first sleeve portion 40 and the second sleeve portion 41 is made of, for example, fused quartz and has a shape of a cylinder whose top and bottom are open. Referring to the example shown in FIG. 1, the sleeve 4 covers an entirety of the main tube portion 9 and about half of each narrow tube portion 10. The sleeve 4 is supported by two sleeve supporting members 4a, which are attached to the frame 6 to hold the sleeve 4 therebetween.

The sleeve 4 may have a single-layer structure or a triple-layer structure instead of a double-layer structure. A sleeve having a multi-layer structure exerts an improved heat retaining effect. Even a sleeve having a single-layer structure exerts the effect of retaining the heat required for the arc tube, as long as the material, shape and dimension of the sleeve are properly selected in conformity with the structure of the arc tube. Moreover, using such a sleeve having the single-layer structure can achieve the advantages of (i) simplifying the structure of the lamp, (ii) reducing the size of the lamp, and (iii) suppressing increase in the cost of the lamp.

A thickness of each of the above sleeves is preferably within a range of 0.5 [mm] to 9.0 [mm]. Here, “a thickness of a sleeve” means (i) a thickness of the sleeve itself when the sleeve has a single-layer structure, and (ii) a radial distance between an inner circumferential surface of the innermost sleeve portion of the sleeve and an outer circumferential surface of the outermost sleeve portion of the sleeve when the sleeve has a multi-layer structure.

By way of example, it has been described above that the sleeve 4 has a cylindrical shape as shown in the example shown in FIG. 1. However, the sleeve 4 is not limited to having a cylindrical shape, but may have any other known shape or any applicable shape that can be ordinarily thought of. In this case also, the same functional effects as those described below can be obtained. It goes without saying that the same functional effects as those described below can be obtained also when the lamp comprises any combination of sleeves having various types of shapes and the above-mentioned arc tubes having various types of shapes.

In the case of the example shown in FIG. 1, the central axis X of the arc tube 3 in the longitudinal direction thereof (see FIG. 1) and the central axis Y of the sleeve 4 in the longitudinal direction thereof (see FIG. 1) are substantially coaxial with each other. It should be mentioned that “substantially coaxial” encompasses not only a case where the central axes X and Y are perfectly coaxial with each other, but also a case where the central axes X and Y are misaligned with each other due to manufacturing variations in lamps. Of course, the central axis X of the arc tube 3 and the central axis Y of the sleeve 4 need not be substantially coaxial with each other. Alternatively, the central axis X of the arc tube 3 and the central axis Y of the sleeve 4 may be misaligned with each other by design to create eccentricity therebetween.

Regardless of whether the central axis X of the arc tube 3 and the central axis Y of the sleeve 4 are substantially coaxial with each other or misaligned with each other by design, the arc tube 3 and the sleeve 4 satisfy the relationship R/r≦−0.0019P+2.625 (where R/r>1), with (i) R denoting an average value [mm] of inner diameters 40a of a part of the first sleeve portion 40 surrounding the part of the discharge space 13 extending between the pair of electrodes 12 (the range denoted by T in FIG. 1) (hereinafter referred to as “average inner diameter R”), (ii) r denoting an average value [mm] of outer diameters 9a of a part of the main tube portion 9 surrounding the part of the discharge space 13 extending between the pair of electrodes 12 (the range denoted by T in FIGS. 1 and 2) (hereinafter referred to as “average outer diameter r”), and (iii) P denoting the power rating [W] of the lamp.

In order to achieve high luminous efficacy, it is preferable that the arc tube 3 and the sleeve 4 also satisfy the relationship −0.0019P+1.79≦R/r.

In a case where both of the relationship 0.7<L/D<3 and the relationship −0.0019P+1.79≦R/r<−0.0019P+2.625 (where R/r>1) are satisfied, the sleeve 4 can retain heat of the arc tube 3, thus raising the operating temperature of the arc tube 3. Accordingly, the metal halide lamp 1 provides the following advantages as compared to a conventional metal halide lamp, which is subjected to a high tube wall loading in order to raise the operating temperature of its arc tube: (i) the tube wall loading of the arc tube 3 is low; and (ii) high luminous efficacy can be yielded from cerium and praseodymium. More specifically, as opposed to a conventional metal halide lamp in which the tube wall loading of an arc tube is within a range of 13 [W/cm²] to 23 [W/cm²], the tube wall loading of the arc tube 3 may be within a range of 9 [W/cm²] to 16 [W/cm²].

In the present embodiment, “tube wall loading” denotes a value obtained by dividing the power rating [W] by a total inner area [cm²] of the arc tube 3 (excluding the narrow tube portions 10).

As a result of thus making the tube wall loading of the arc tube 3 lower than that of an arc tube in a conventional metal halide lamp, it is possible to (i) prevent flicker in the illuminated surface of the arc tube 3, which is caused by violent movement of the electric arc especially when the metal halide lamp 1 is lit while being tilted, (ii) suppress an early reduction in the luminous flux maintenance factor, and (iii) suppress formation of cracks in the enclosure 11 of the arc tube 3.

Note that when the sleeve 4 has a double-layer structure as shown in FIG. 1, the first sleeve portion 40, which is the innermost sleeve portion of the sleeve 4, determines the average inner diameter R of the sleeve 4.

According to the structure of the above metal halide lamp pertaining to the first embodiment of the present invention, the outer diameter of the arc tube 3 and the inner diameter of the sleeve 4 have been adjusted so that L/D satisfies the relationship 0.7<L/D<3 and the dimensional rate R/r satisfies the relationship R/r≦−0.0019P+2.625 (where R/r>1). This way, the heat retaining effect of the sleeve 4 can raise the operating temperature of the arc tube 3, without having to increase the tube wall loading by reducing the size of the arc tube 3 with respect to a predetermined power rating P. Therefore, even when cerium and/or praseodymium that have low vapor pressures are enclosed as a light emitting material, the above structure can yield enhanced light emission from cerium and/or praseodymium and hence improve the luminous efficacy.

However, even when L/D satisfies the relationship 0.7<L/D<3, if the dimensional rate R/r satisfies the relationship R/r<−0.0019P+1.79 (where R/r>1), there is a possibility that high luminous efficacy cannot be achieved despite the fact that cerium and/or praseodymium are enclosed as a light emitting material.

Provided that the tube wall loading of the arc tube 3 stays constant, if the average inner diameter R of the sleeve 4 is reduced so as to make the average outer diameter r of the main tube portion 9 large relative to the average inner diameter R of the sleeve 4, then the dimensional rate R/r becomes smaller, and the sleeve 4 and the arc tube 3 become more adjacent to each other. When the sleeve 4 and the arc tube 3 become too adjacent to each other, the sleeve 4's effect of retaining heat of the arc tube 3 remains at a high level. From this point on, the adjacency between the sleeve 4 and the arc tube 3, by itself, cannot raise the operating temperature of the arc tube 3, and further improvement in the luminous efficacy cannot be expected, either. In order to raise the operating temperature (operating pressure) of the arc tube 3 to the extent that enhanced light emission is yielded from cerium and praseodymium, it is required not only to bring the sleeve 4 adjacent to the arc tube 3, but also to increase the tube wall loading to some extent. Similarly, the dimensional rate R/r becomes small also when the average outer diameter r of the main tube portion 9 is increased. In this case, the luminous efficacy is reduced presumably because reduction in the tube wall loading of the arc tube 3 results in a situation where the operating temperature of the arc tube 3 cannot be raised to the extent that high luminous efficacy is yielded from cerium and praseodymium. Accordingly, in order to unfailingly achieve high luminous efficacy, it is preferable for the dimensional rate R/r to satisfy the relationship −0.0019P+1.79≦R/r.

Furthermore, since the tube wall loading is not increased in the present embodiment as has been described above, the present embodiment can suppress extreme thinning of the electric arc and violent movement of the electric arc. Hence, flicker in the illuminated surface of the arc tube 3, which is caused by the violent movement of the electric arc, can be prevented.

Furthermore, as a result of thus suppressing the violent movement of the electric arc, an abnormal local temperature increase in the arc tube 3 can be suppressed. Consequently, it is possible to suppress scattering of materials constituting the enclosure 11, which is caused by such an abnormal local temperature increase, and to prevent an early reduction in the luminous flux maintenance factor. Moreover, as a result of suppressing such an abnormal local temperature increase in the arc tube 3, it is also possible to suppress growth in unevenness of the temperature distribution in the arc tube 3. Consequently, the thermal stress applied to the enclosure 11 is alleviated, and formation of cracks in the enclosure 11 is prevented.

Meanwhile, even when L/D satisfies the relationship 0.7<L/D<3, the following problems (1) to (3) may occur if the dimensional rate R/r satisfies the relationship R/r>−0.0019P+2.625 (where R/r>1).
(1) Provided that the tube wall loading of the arc tube 3 stays constant, if the average inner diameter R of the sleeve 4 is increased so as to make the average outer diameter r of the main tube portion 9 small relative to the average inner diameter R of the sleeve 4, then the dimensional rate R/r becomes larger, and the sleeve 4 and the arc tube 3 become more distanced from each other. When the sleeve 4 and the arc tube 3 become too distanced from each other, the sleeve 4's effect of retaining heat of the arc tube 3 decreases. As a result, it becomes impossible to reduce the difference between (i) the temperature of a radially central area of the space within the main tube portion 9, and (ii) the temperature of a circumferential area of the space within the main tube portion 9 that is in the vicinity of the tube wall and located more outward in the radial direction than the radially central area is. Consequently, the convection of a gas that fills the arc tube 3 cannot be restrained. Especially when the metal halide lamp 1 is lit while being tilted, the electric arc moves violently under the influence of the convection of the gas, triggering the flicker. Similarly, the dimensional rate R/r becomes large also when the size of the arc tube 3 is reduced. In this case, the tube wall loading is increased. Consequently, the electric arc, which is already made thin due to use of cerium and/or praseodymium as a light emitting material as described above, is further thinned because of the increased tube wall loading. This causes the electric arc to move violently, triggering the flicker in the illuminated surface of the arc tube 3. When the tube wall loading is thus increased, the temperature of the radially central area of the space within the main tube portion 9 is further raised. As a result, the heat retaining effect of the sleeve 4 cannot reduce the aforementioned temperature difference. This causes the electric arc to move violently, triggering the flicker.
(2) Another problem is an early reduction in the luminous flux maintenance factor. The inventors have found that this problem is caused by the following reasons. When the metal halide lamp 1 is lit while being tilted, the violent movement of the electric arc, which has been described in the above (1), causes the electric arc to be displaced instantaneously and repeatedly. Moreover, between the pair of electrodes 12 arranged in the arc tube 3, the displacement of the electric arc is not only inconsistent but also large in extent. This results in an abnormal local temperature increase in the arc tube 3. Put another way, the extremely thin and high-temperature electric arc changes the crystal structure of a ceramic, such as alumina, constituting the enclosure 11 of the arc tube 3, promoting evaporation thereof and causing scattered alumina particles to attach to the inner surface of the sleeve 4.
(3) Furthermore, when the metal halide lamp 1 is lit while being tilted, there is a possibility that cracks form in the enclosure 11 of the arc tube 3. This problem is considered to be caused by the following reasons. As with the case of the above (2), the violent movement of the electric arc causes the electric arc to be displaced instantaneously and repeatedly. Moreover, between the pair of electrodes 12, the displacement of the electric arc is not only inconsistent but also large in extent. This causes an abnormal local temperature increase in the arc tube 3, as well as unevenness of the temperature distribution in the arc tube 3. As a result, the thermal stress applied to the enclosure 11 is increased.

When the dimensional rate R/r satisfies the relationship −0.0019P+1.79≦R/r (where R/r>1), the light emitting rates of cerium and praseodymium are improved if the mole fraction of a sum of cerium and praseodymium in the total amount of light emitting materials enclosed (excluding mercury) is 11.8 [mol %] or more. Improvement in the luminous efficacy leads to improvements in the initial properties, namely a total luminous flux [lm] and a general color rendering index [Ra] measured after 100 hours of lighting. When cerium and praseodymium are enclosed in a conventional metal halide lamp in such a manner that the mole fraction of the sum of cerium and praseodymium in the total amount of light emitting materials enclosed (excluding mercury) is 11.8 [mol %] or greater, the electric arc of the conventional metal halide lamp tends to become even more thinner while the lamp is being lit. As a result, in such a conventional metal halide lamp, the aforementioned violent movement of the electric arc is further enhanced, and the problems such as flicker in the illuminated surface of the arc tube, an early reduction in the luminous flux maintenance factor, and cracking of the enclosure, become more prominent. In contrast, the metal halide lamp 1 of the present invention can solve these problems, and achieve the above-described functional effects in a remarkable manner.

The inventors have conducted experiments to confirm the functional effects of the metal halide lamps 1 pertaining to the first embodiment of the present invention. The following describes exemplary experiments conducted on the metal halide lamps 1 each having a power rating of 180 [W], 250 [W] or 400 [W].

<Experiment 1>

The following describes experiments conducted on the metal halide lamps 1 having a power rating of 250 [W].

(Luminous Flux Maintenance Factor)

In Experiment 1, the inventors created metal halide lamps that had (i) the same average inner diameter R, (ii) different average outer diameters r, and therefore (iii) different “L/D”s (with each L/D satisfying the relationship 0.7<L/D<3). The inventors measured and evaluated the luminous flux maintenance factors of the created lamps. Note that it was required for R to satisfy the relationship 10≦R<50 [m], because when constructing each lamp, the sleeve for surrounding the arc tube had to be inserted through a neck portion of the outer tube.

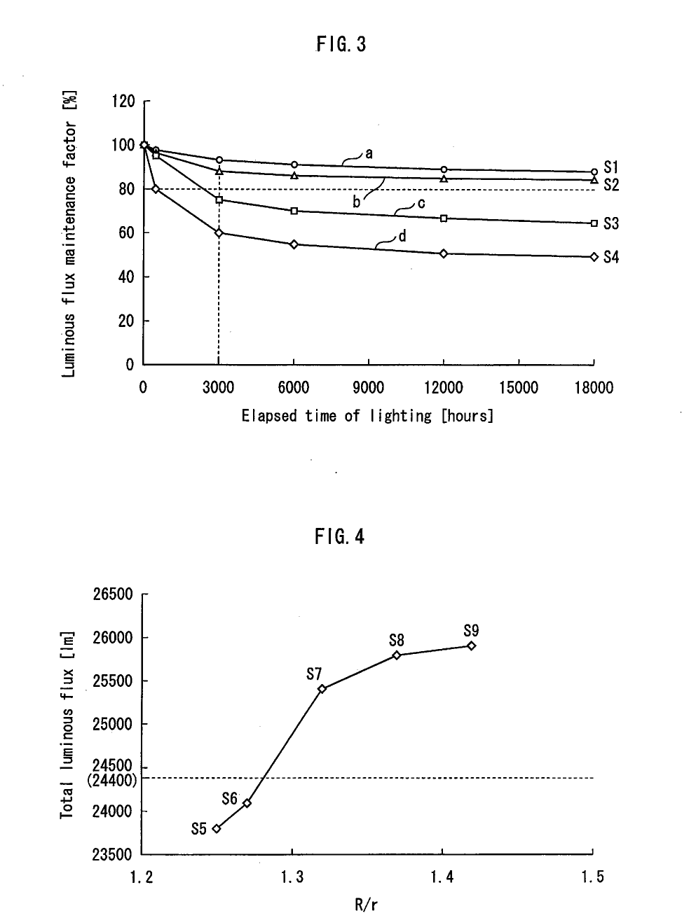

To begin with, the inventors created samples S1 to S4 as metal halide lamps, which respectively had “R/r”s of 2.1, 2.15, 2.2 and 2.25. Samples S1 to S4 are respectively indicated by solid lines “a” to “d” in FIG. 3.

These samples S1 to S4 had the following measurements for a distance L [mm] between the pair of electrodes 12, the largest inner diameter D [mm] of a part of the arc tube 3 surrounding the part of the discharge space 13 extending between the pair of electrodes 12, an average value R [mm] of inner diameters 40a of a part of the first sleeve portion 40 surrounding the part of the discharge space 13 extending between the pair of electrodes 12, an average value r [mm] of outer diameters 9a of a part of the main tube portion 9 surrounding the part of the discharge space 13 extending between the pair of electrodes 12, and tube wall loading [W/cm²].

Sample S1: L=25, D=14.5, R=35.5, r=16.9, tube wall loading=9

Sample S2: L=23, D=14.1, R=35.5, r=16.5, tube wall loading=15

Sample S3: L=20, D=13.7, R=35.5, r=16.1, tube wall loading=20

Sample S4: L=18, D=13.4, R=35.5, r=15.8, tube wall loading=23

Subsequently, each of the created samples S1 to S4 was lit at the stated power rating while being tilted by 45[°] with the aid of a known magnetic ballast. The inventors researched whether they could visually confirm flicker in the illuminated surface of the arc tube in each sample, as well as the luminous flux maintenance factor [%] of each sample. The results of researching the luminous maintenance factor of each sample are shown in FIG. 3.

Note, a “luminous flux maintenance factor [%]” means the rate of luminous flux of a lamp measured after a predetermined time period of lighting to luminous flux of the lamp measured after 100 hours of lighting, with the latter luminous flux considered to be 100[%]. Here, a lighting method involved repeated ON/OFF cycles of 5.5 hours ON and 0.5 hours OFF. The inventors had acknowledged from their experiences that a luminous flux maintenance factor of a lamp does not reduce to a large extent after 3000 hours of lighting. It is therefore determinable that a lamp fulfills a rated life (18000 hours) if it has an excellent luminous flux maintenance factor, or more specifically, a luminous flux maintenance factor of 80[%] or more, after 3000 hours of lighting. Accordingly, in the present Experiment 1, the inventors judged a luminous maintenance factor of a lamp to be (i) “excellent” if it was 80[%] or more after 3000 hours of lighting, and (ii) “poor” if it was less than 80[%] after 3000 hours of lighting. The same rule applies to Experiment 2, which will be described later.

Also note that in each of the above metal halide lamps 1 (i.e., samples S1 to S4), cerium iodide, sodium iodide and thulium iodide were enclosed as light emitting materials in the composition ratio (mole ratio) 13.3:80.5:6.2, with a total amount of the enclosed iodides being 13 [mg]. Mercury was also enclosed at 50 [mg]. The same conditions apply to samples S5 to S9, which will be described later.

The inventors confirmed no visible flicker in the illuminated surfaces of the arc tubes in samples S1 (R/r=2.1) and S2 (R/r=2.15). As is apparent from FIG. 3, the inventors also confirmed that both of samples S1 and S2 had excellent luminous flux maintenance factors. In contrast, the inventors confirmed visible flicker in the illuminated surfaces of the arc tubes in samples S3 (R/r=2.2) and S4 (R/r=2.25). As is obvious from FIG. 3, the inventors also confirmed that both of samples S3 and S4 had poor luminous flux maintenance factors. In studying the inner surfaces of the sleeves 4 in samples S3 and S4, the inventors found alumina particles, which were the materials constituting the enclosures 11, attached to and staining said inner surfaces. This is considered to be the cause of an early reduction in the luminous flux maintenance factors.

Furthermore, cracks formed in neither the enclosure 11 of sample S1 nor the enclosure 11 of sample S2. In contrast, cracks formed in the enclosures 11 of samples S3 and S4, resulting in lamp operation failures.

(Total Luminous Flux and General Color Rendering Index)

The inventors also created metal halide lamps 1 that had (i) the same power rating of 250 [W], (ii) the same average inner diameter R, (iii) different average outer diameters r, and therefore (iv) different “L/D”s (with each L/D satisfying the relationship 0.7<L/D<3). The inventors measured and evaluated the total luminous fluxes and the general color rendering indexes of the created lamps. Note that it was required for R to satisfy the relationship 10≦R<50 [mm], because when constructing each lamp, the sleeve for surrounding the arc tube had to be inserted through a neck portion of the outer tube.

To begin with, the inventors created samples S5 to S9 as metal halide lamps, which respectively had “R/r”s of 1.25, 1.27, 1.32, 1.37 and 1.42.

These samples S5 to S9 had the following measurements for a distance L [mm], the largest inner diameter D [mm], an average value R [mm], an average value r [mm], and tube wall loading [W/cm²].

Sample S5: L=24, D=17.6, R=25, r=20, tube wall loading=7

Sample S6: L=23, D=17.3, R=25, r=19.7, tube wall loading=8

Sample S7: L=22, D=16.5, R=25, r=18.9, tube wall loading=9

Sample S8: L=21, D=15.8, R=25, r=18.2, tube wall loading=11

Sample S9: L=20, D=15.2, R=25, r=17.6, tube wall loading=13

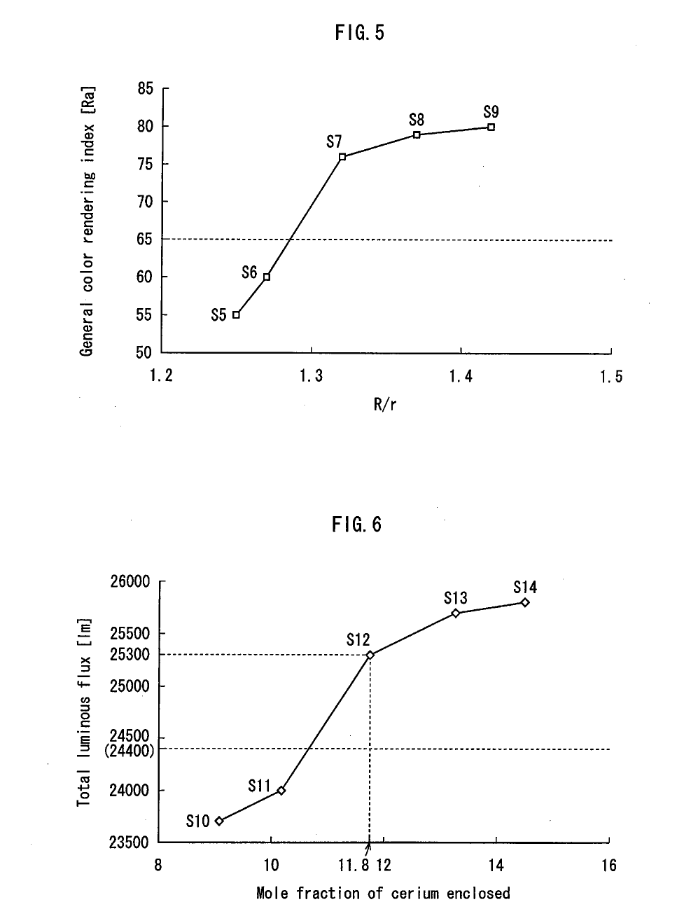

Subsequently, each of the created samples S5 to S9 was lit at the stated power rating while standing vertically with the aid of a known magnetic ballast. The inventors researched the total luminous flux [lm] (FIG. 4) and the general color rendering index [Ra] (FIG. 5) of each sample after 100 hours of lighting. The research results are shown in FIGS. 4 and 5.

As is apparent from FIGS. 4 and 5, it was confirmed that initial total luminous fluxes and initial general color rendering indexes [Ra] of samples S5 (R/r=1.25) and S6 (R/r=1.27) were poor. In contrast, it was confirmed that initial total luminous fluxes and initial general color rendering indexes [Ra] of samples S7 (R/r=1.32), S8 (R/r=1.37) and S9 (R/r=1.42) were superior to those of a conventional metal halide lamp.

Note that a conventional metal halide lamp with a power rating of 250 [W] has a total luminous flux of 24400 [lm] and a general color rendering index [Ra] of 65.

(Total Luminous Flux and General Color Rendering Index in a Case where Mole Fraction of Cerium Enclosed is Changed)

The inventors also created metal halide lamps 1 that had (i) the same power rating of 250 [W], (ii) L/D satisfying the relationship 0.7<L/D<3, (iii) the same R/r of 1.315, and (iv) cerium enclosed therein at different mole fractions. The inventors measured and evaluated the total luminous fluxes and the general color rendering indexes of the created lamps. To begin with, the inventors created samples S10 to S14 as metal halide lamps, in which cerium was enclosed at mole fractions of 9.1 [mol %], 10.2 [mol %], 11.8 [mol %], 13.3 [mol %] and 14.5 [mol %], respectively.

These samples S10 to S14 had the following measurements for a distance L [mm], the largest inner diameter D [mm], an average value R [mm], an average value r [mm], and tube wall loading [W/cm²].

Samples S10 to S14: L=21, D=17.6, R=26.3, r=20, tube wall loading=10

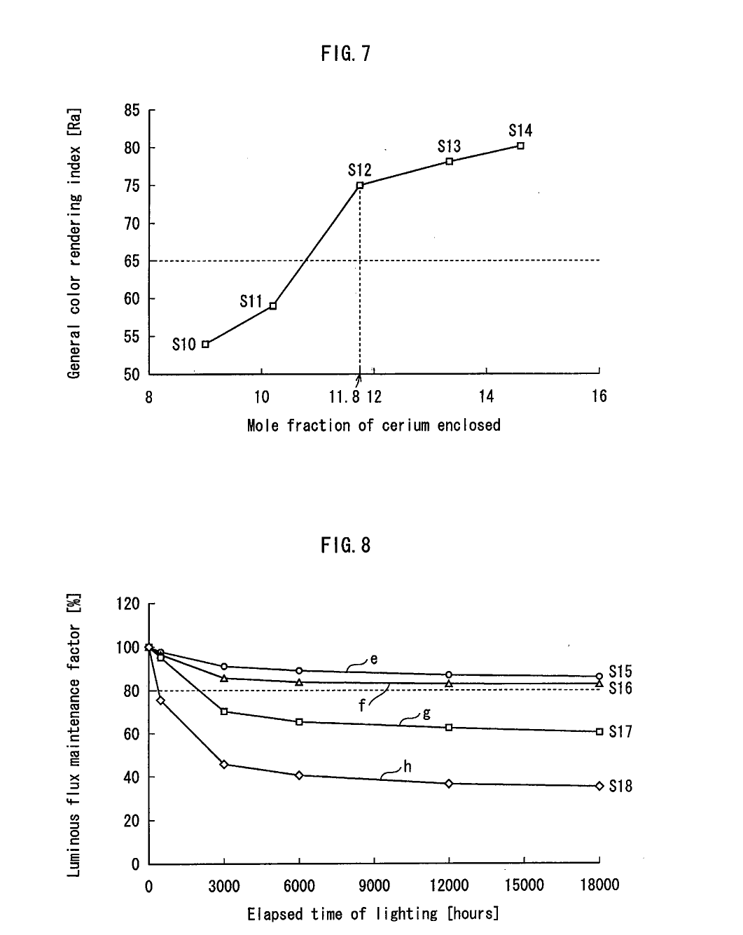

Subsequently, each of the created samples S10 to S14 was lit at the stated power rating while standing vertically with the aid of a known magnetic ballast. The inventors researched the total luminous flux [lm] (FIG. 6) and the general color rendering index [Ra] (FIG. 7) of each sample after 100 hours of lighting. The research results are shown in FIGS. 6 and 7.

Note that cerium iodide, sodium iodide and thulium iodide were enclosed in each of samples S10 to S14 as light emitting materials, with a total amount of the enclosed iodides being 13 [mg]. Mercury was also enclosed at 50 [mg].

As is apparent from FIGS. 6 and 7, it was confirmed that initial total luminous fluxes and initial general color rendering indexes [Ra] of samples S10 and S11 (mole fractions of cerium enclosed=9.1 [mol %] and 10.2 [mol %], respectively) were poor. In contrast, it was confirmed that initial total luminous fluxes and initial general color rendering indexes [Ra] of samples S12, S13 and S14 (mole fractions of cerium enclosed=11.8 [mol %], 13.3 [mol %] and 14.5 [mol %], respectively) were superior to those of a conventional metal halide lamp.

It was also confirmed that when praseodymium was enclosed in place of or in addition to cerium, the early total luminous flux and the early general color rendering index [Ra] of each metal halide lamp created in Experiment 1 were superior to those of a conventional metal halide lamp, as long as a mole fraction of praseodymium or a sum of cerium and praseodymium enclosed was 11.8 [mol %] or more.

<Experiment 2>

The following describes experiments conducted on the metal halide lamps 1 having a power rating of 400 [W].

(Luminous Flux Maintenance Factor)

In Experiment 2 also, the inventors created metal halide lamps that had (i) the same average inner diameter R, (ii) different average outer diameters r, and therefore (iii) different “L/D”s each satisfying the relationship 0.7<L/D<3. The inventors measured and evaluated the luminous flux maintenance factors of the created lamps. Note that as with Experiment 1, it was required for R to satisfy the relationship R≦50 [mm], because when constructing each lamp, the sleeve for surrounding the arc tube had to be inserted through a neck portion of the outer tube.

To begin with, the inventors created samples S15 to S18 as metal halide lamps, which respectively had “R/r”s of 1.81, 1.86, 1.91 and 1.96. Samples S15 to S18 are respectively indicated by solid lines “e” to “h” in FIG. 8.

These samples S15 to S18 had the following measurements for a distance L [mm], the largest inner diameter D [mm], an average value R [mm], an average value r [mm], and tube wall loading [W/cm²].

Sample S15: L=36, D=19.2, R=39, r=21.6, tube wall loading=9

Sample S16: L=32, D=18.6, R=39, r=21, tube wall loading=16

Sample S17: L=29, D=18, R=39, r=20.4, tube wall loading=20

Sample S18: L=28, D=17.5, R=39, r=19.9, tube wall loading=22

Subsequently, each of the created samples S15 to S18 was lit at the stated power rating while being tilted by 45[°] with the aid of a known magnetic ballast. The inventors researched whether they could visually confirm flicker in the illuminated surface of the arc tube in each sample, as well as the luminous flux maintenance factor [%] of each sample. The results of researching the luminous maintenance factor of each sample are shown in FIG. 8.

Note that in each of the above metal halide lamps 1 (i.e., samples S15 to S18), cerium iodide, sodium iodide and thulium iodide were enclosed as light emitting materials in the composition ratio (mole ratio) 12:82.4:5.6, with a total amount of the enclosed iodides being 25 [mg]. Mercury was also enclosed at 57 [mg]. The same conditions apply to samples S19 to S23, which will be described later.

The inventors confirmed no visible flicker in the illuminated surfaces of the arc tubes in samples S15 (R/r=1.81) and S16 (R/r=1.86). As is apparent from FIG. 8, the inventors also confirmed that both of samples S15 and S16 had excellent luminous flux maintenance factors. In contrast, the inventors confirmed visible flicker in the illuminated surfaces of the arc tubes in samples S17 (R/r=1.91) and S18 (R/r=1.96). As is obvious from FIG. 8, the inventors also confirmed that both of samples S17 and S18 had poor luminous flux maintenance factors. In studying the inner surfaces of the sleeves 4 in samples S17 and S18, the inventors found alumina particles, which were the materials constituting the enclosures 11, attached to and staining said inner surfaces, as with the cases of samples S3 and S4.

Furthermore, cracks formed in neither the enclosure 11 of sample S15 nor the enclosure 11 of sample S16. In contrast, cracks formed in the enclosures 11 of samples S17 and S18, resulting in lamp operation failures.

(Total Luminous Flux and General Color Rendering Index)

The inventors also created metal halide lamps 1 that had (i) the same power rating of 400 [W], (ii) the same average inner diameter R, (iii) different average outer diameters r, and therefore (iv) different “L/D”s each satisfying the relationship 0.7<L/D<3. The inventors measured and evaluated the total luminous fluxes and the general color rendering indexes of the created lamps. Note that it was required for R to satisfy the relationship 10≦R<50 [mm], because when constructing each lamp, the sleeve for surrounding the arc tube had to be inserted through a neck portion of the outer tube.

To begin with, the inventors created samples S19 to S23 as metal halide lamps, which respectively had “R/r”s of 1.01, 1.02, 1.03, 1.07 and 1.11.

These samples S19 to S23 had the following measurements for a distance L [mm], the largest inner diameter D [mm], an average value R [mm], an average value r [mm], and tube wall loading [W/cm²].

Sample S19: L=35, D=25.2, R=28, r=27.6, tube wall loading=7

Sample S20: L=34, D=25, R=28, r=27.4, tube wall loading=8

Sample S21: L=33, D=24.7, R=28, r=27.1, tube wall loading=9

Sample S22: L=31, D=23.8, R=28, r=26.2, tube wall loading=12

Sample S23: L=30, D=22.9, R=28, r=25.3, tube wall loading=14

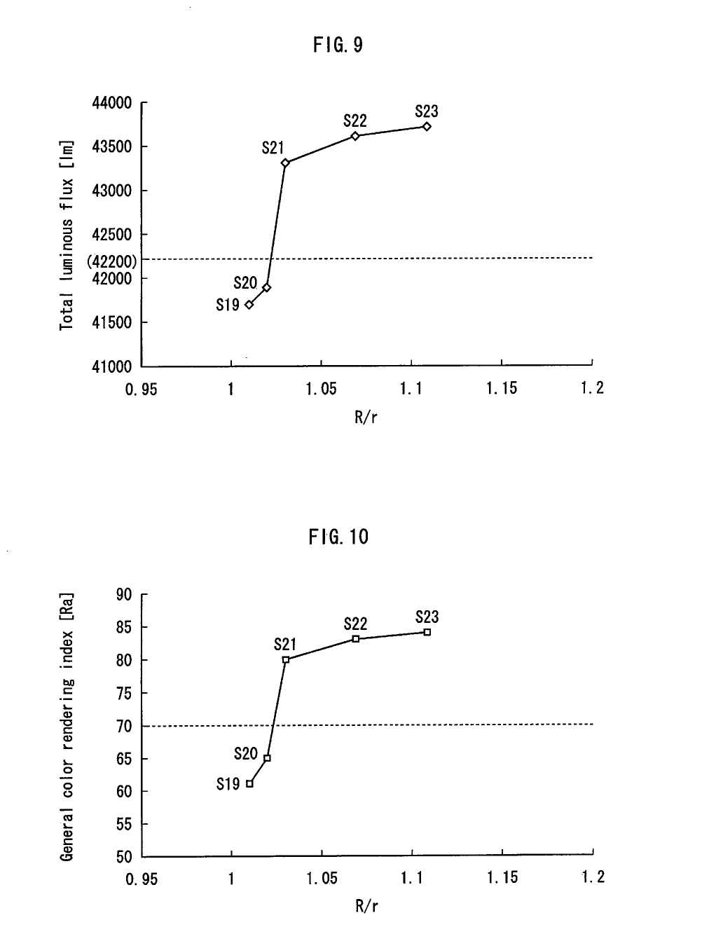

Subsequently, each of the created samples S19 to S23 was lit at the stated power rating while standing vertically with the aid of a known magnetic ballast. The inventors researched the total luminous flux [lm] (FIG. 9) and the general color rendering index [Ra] (FIG. 10) of each sample after 100 hours of lighting. The research results are shown in FIGS. 9 and 10.

As is apparent from FIGS. 9 and 10, it was confirmed that initial total luminous fluxes and initial general color rendering indexes [Ra] of samples S19 (R/r=1.01) and S20 (R/r=1.02) were poor. In contrast, it was confirmed that initial total luminous fluxes and initial general color rendering indexes [Ra] of samples S21 (R/r=1.03), S22 (R/r=1.07) and S23 (R/r=1.11) were superior to those of a conventional metal halide lamp.

Note that a conventional metal halide lamp with a power rating of 400 [W] has a total luminous flux of 42200 [lm] and a general color rendering index [Ra] of 70.

(Total Luminous Flux and General Color Rendering Index in a Case where Mole Fraction of Cerium Enclosed is Changed)

The inventors also created metal halide lamps 1 which had (i) the same power rating of 400 [W], (ii) L/D satisfying the relationship 0.7<L/D<3, (iii) the same R/r of 1.03, and (iv) cerium enclosed therein at different mole fractions. The inventors measured and evaluated total luminous fluxes and general color rendering indexes of the created lamps.

To begin with, the inventors created samples S24 to S28 as metal halide lamps, in which cerium was enclosed respectively at mole fractions of 9.1 [mol %], 10.2 [mol %], 11.8 [mol %], 13.3 [mol %] and 14.5 [mol %].

These samples S24 to S28 had the following measurements for a distance L [mm], the largest inner diameter D [mm], an average value R [mm], an average value r [mm], and tube wall loading [W/cm²].

Samples S24 to S28: L=32, D=23.7, R=27, r=26.1, tube wall loading=11

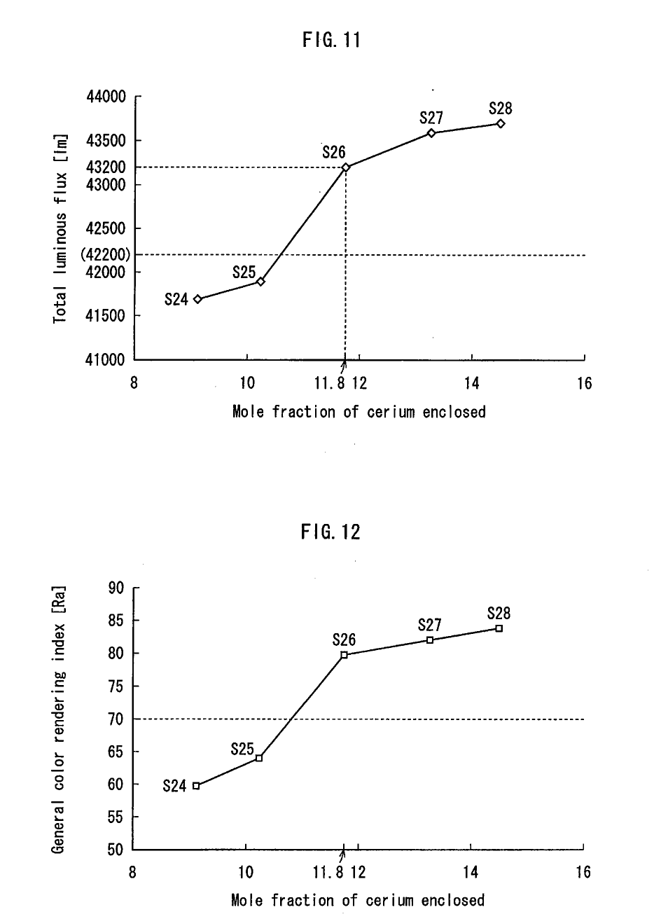

Subsequently, each of the created samples S24 to S28 was lit at the stated power rating while standing vertically with the aid of a known magnetic ballast. The inventors researched the total luminous flux [lm] (FIG. 11) and the general color rendering index [Ra] (FIG. 12) of each sample after 100 hours of lighting. The research results are shown in FIGS. 11 and 12.

Note that cerium iodide, sodium iodide and thulium iodide were enclosed in each of the samples S24 to S28 as light emitting materials, with a total amount of the enclosed iodides being 25 [mg]. Mercury was also enclosed at 57 [mg].

As is apparent from FIGS. 11 and 12, it was confirmed that initial total luminous fluxes and initial general color rendering indexes [Ra] of samples S24 and S25 (mole fractions of cerium enclosed=9.1 [mol %] and 10.2 [mol %], respectively) were poor. In contrast, it was confirmed that initial total luminous fluxes and initial general color rendering indexes [Ra] of samples S26, S27 and S28 (mole fractions of cerium enclosed=11.8 [mol %], 13.3 [mol %] and 14.5 [mol %], respectively) were superior to those of a conventional metal halide lamp.

As with the case of Experiment 1, it was also confirmed that when praseodymium was enclosed in place of or in addition to cerium, the early total luminous flux and the early general color rendering index [Ra] of each metal halide lamp created in Experiment 2 were superior to those of a conventional metal halide lamp, as long as a mole fraction of praseodymium or a sum of cerium and praseodymium enclosed was 11.8 [mol %] or more.

<Experiment 3>

(Luminous Flux Maintenance Factor)

Finally, the following describes experiments conducted on metal halide lamps 1 having a power rating of 180 [W]. The inventors created metal halide lamps that had (i) the same average inner diameter R, (ii) different average outer diameters r, and therefore (iii) different “L/D”s each satisfying the relationship 0.7<L/D<3. The inventors measured and evaluated the luminous flux maintenance factors of the created lamps. Note that as with Experiments 1 and 2, it was required for R to satisfy the relationship 10≦R<50 [mm], because when constructing each lamp, the sleeve for surrounding the arc tube had to be inserted through a neck portion of the outer tube.

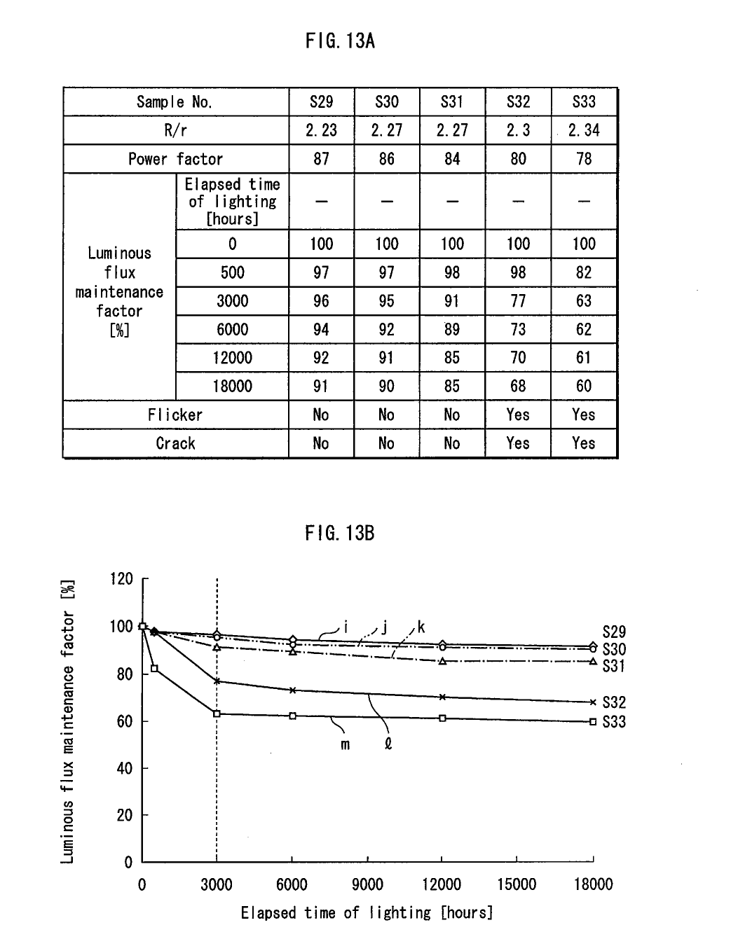

To begin with, the inventors created samples S29 to S33 as metal halide lamps, which respectively had “R/r”s of 2.23, 2.27, 2.27, 2.30 and 2.34. Samples S29 to S33 are respectively indicated by solid lines “i” to “m” in FIG. 13B.

These samples S29 to S33 had the following measurements for a distance L [mm], the largest inner diameter D [mm], an average value R [mm], an average value r [mm], and tube wall loading [W/cm²].

Sample S29: L=20, D=10.6, R=29, r=13, tube wall loading=9

Sample S30: L=18, D=10.4, R=29, r=12.8, tube wall loading=14

Sample S31: L=15, D=10.4, R=29, r=12.8, tube wall loading=16

Sample S32: L=13, D=10.2, R=29, r=12.6, tube wall loading=20

Sample S33: L=11, D=10, R=29, r=12.4, tube wall loading=23

Subsequently, each of the created samples S29 to S32 was lit at the stated power rating while being tilted by 45[°] with the aid of a known magnetic ballast. The inventors researched whether they could visually confirm flicker in the illuminated surface of the arc tube in each sample, as well as the luminous flux maintenance factor [%] of each sample. The results of researching the luminous maintenance factor of each sample are shown in FIGS. 13A and 13B.

Note that in Experiment 3, the inventors measured/evaluated not only the luminous flux maintenance factors but also the power factors of samples S29 to S33 as shown in FIGS. 13A and 13B. Reference will be made to the power factors later when describing the relationship between a luminous flux maintenance factor and a power factor.

Also note that in each of the above metal halide lamps 1 (i.e., samples S29 to S32), cerium iodide, sodium iodide and thulium iodide were enclosed as light emitting materials in the composition ratio (mole ratio) 12.5:82.2:5.3, with a total amount of the enclosed iodides being 7 [mg]. Mercury was also enclosed at 43 [mg]. The same conditions apply to samples S34 to S38, which will be described later.

The inventors confirmed no visible flicker in the illuminated surfaces of the arc tubes in samples S29 (R/r=2.23), S30 (R/r=2.27) and S31 (R/r=2.27). As is apparent from FIGS. 13A and 13B, the inventors also confirmed that all of samples S29, S30 and S31 had excellent luminous flux maintenance factors. In contrast, the inventors confirmed visible flicker in the illuminated surfaces of the arc tubes in samples S32 (R/r=2.30) and S33 (R/r=2.34). As is obvious from FIGS. 13A and 13B, the inventors also confirmed that both of samples S32 and S33 had poor luminous flux maintenance factors. In studying the inner surfaces of the sleeves 4 in samples S32 and S33, the inventors found alumina particles, which were the materials constituting the enclosures 11, attached to and staining said inner surfaces, as with the cases of samples S3 and S4.

Furthermore, cracks formed in neither the enclosure 11 of sample S29 nor the enclosure 11 of sample S31. In contrast, cracks formed in the enclosures 11 of samples S32 and S33, resulting in lamp operation failures.

(Total Luminous Flux and General Color Rendering Index)

The inventors also created metal halide lamps 1 that had (i) the same power rating of 180 [W], (ii) the same average inner diameter R, (iii) different average outer diameters r, and therefore (iv) different “L/D”s each satisfying the relationship 0.7<L/D<3. The inventors measured and evaluated the total luminous fluxes and the general color rendering indexes of the created lamps. In Experiment 3 also, it was required for R to satisfy the relationship 10≦R<50 [mm], because when constructing each lamp, the sleeve for surrounding the arc tube had to be inserted through a neck portion of the outer tube.

To begin with, the inventors created samples S34 to S38 as metal halide lamps, which respectively had “R/r”s of 1.38, 1.41, 1.45, 1.49 and 1.54.

These samples S34 to S38 had the following measurements for a distance L [mm], the largest inner diameter D [mm], an average value R [mm], an average value r [mm], and tube wall loading [W/cm²].

Sample S34: L=19, D=13.6, R=22, r=16, tube wall loading=7

Sample S35: L=18, D=13.2, R=22, r=15.6, tube wall loading=8

Sample S36: L=17, D=12.8, R=22, r=15.2, tube wall loading=9

Sample S37: L=16, D=12.4, R=22, r=14.8, tube wall loading=11

Sample S38: L=13, D=11.9, R=22, r=14.3, tube wall loading=14

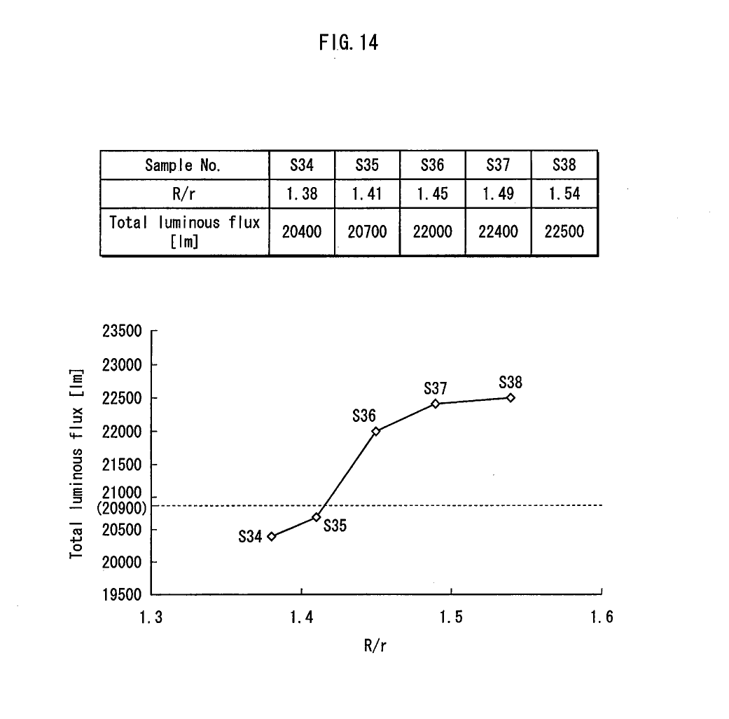

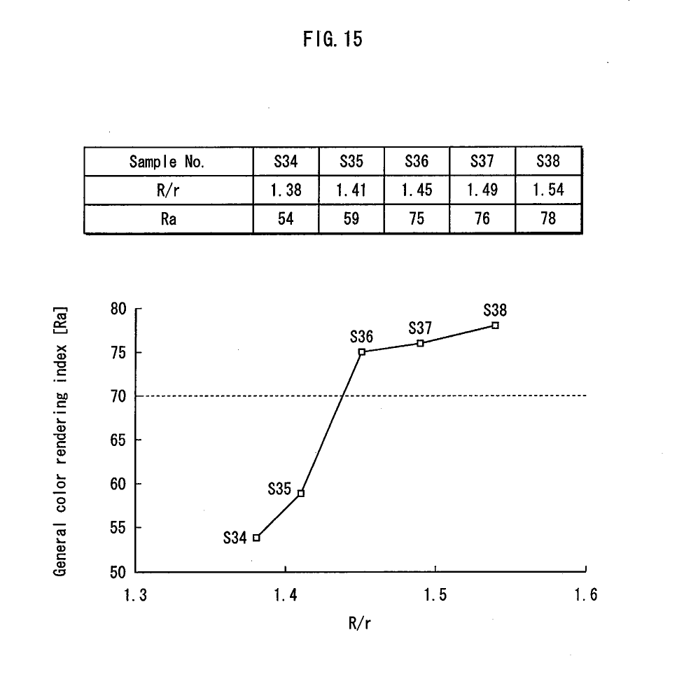

Subsequently, each of the created samples S34 to S38 was lit at the stated power rating while standing vertically with the aid of a known magnetic ballast. The inventors researched the total luminous flux [lm] (FIG. 14) and the general color rendering index [Ra] (FIG. 15) of each sample after 100 hours of lighting. The research results are shown in FIGS. 14 and 15.

As is apparent from FIGS. 14 and 15, it was confirmed that initial total luminous fluxes and initial general color rendering indexes [Ra] of samples S34 (R/r=1.38) and S35 (R/r=1.41) were poor. In contrast, it was confirmed that initial total luminous fluxes and initial general color rendering indexes [Ra] of samples S36 (R/r=1.45), S37 (R/r=1.49) and S38 (R/r=1.54) were superior to those of a conventional metal halide lamp.

Note that a conventional metal halide lamp with a power rating of 180 [W] has a total luminous flux of 20900 [lm] and a general color rendering index [Ra] of 70.

(Total Luminous Flux and General Color Rendering Index in a Case where Mole Fraction of Cerium Enclosed is Changed)

The inventors also created metal halide lamps that had (i) the same power rating of 180 [W], (ii) L/D satisfying the relationship 0.7<L/D<3, (iii) the same R/r of 1.45, (iii) different, and (iv) cerium enclosed therein at different mole fractions. The inventors measured and evaluated total luminous fluxes and general color rendering indexes of the created lamps.

To begin with, the inventors created samples S39 to S43 as metal halide lamps, in which cerium was enclosed respectively at mole fractions of 9.1 [mol %], 10.2 [mol %], 11.8 [mol %], 13.3 [mol %] and 14.5 [mol %].

These samples S39 to S43 had the following measurements for a distance L [mm], the largest inner diameter D [mm], an average value R [mm], an average value r [mm], and tube wall loading [W/cm²].

Samples S39 to S43: L=16, D=11.4, R=20, r=13.8, tube wall loading=12

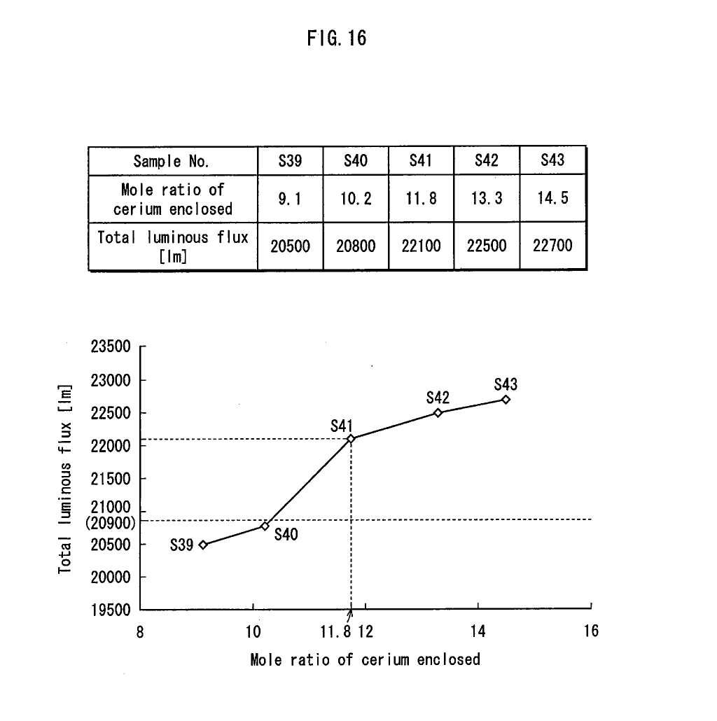

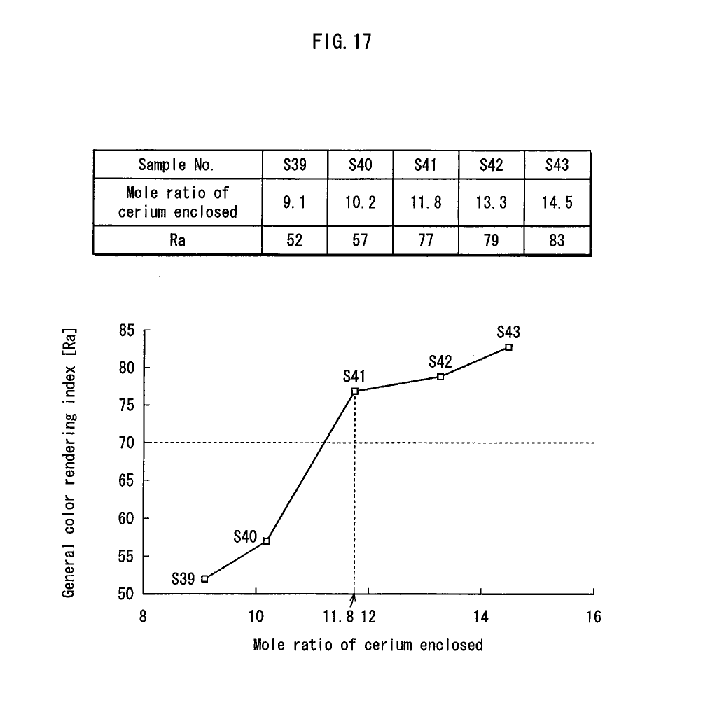

Subsequently, each of the created samples S39 to S43 was lit at the stated power rating while standing vertically with the aid of a known magnetic ballast. The inventors researched the total luminous flux [lm] (FIG. 16) and the general color rendering index [Ra] (FIG. 17) of each sample after 100 hours of lighting. The research results are shown in FIGS. 16 and 17.

Note that cerium iodide, sodium iodide and thulium iodide were enclosed in each of samples S39 to S43 as light emitting materials, with a total amount of the enclosed iodides being 7 [mg]. Mercury was also enclosed at 43 [mg].

As is apparent from FIGS. 16 and 17, it was confirmed that initial total luminous fluxes and initial general color rendering indexes [Ra] of samples S39 and S40 (mole fractions of cerium enclosed=9.1 [mol %] and 10.2 [mol %], respectively) were poor. In contrast, it was confirmed that initial total luminous fluxes and initial general color rendering indexes [Ra] of samples S41, S42 and S43 (mole fractions of cerium enclosed=11.8 [mol %], 13.3 [mol %] and 14.5 [mol %], respectively) were superior to those of a conventional metal halide lamp.

It was also confirmed that when praseodymium was enclosed in place of or in addition to cerium, the early total luminous flux and the early general color rendering index [Ra] of each metal halide lamp created in Experiment 3 were superior to those of a conventional metal halide lamp, as long as a mole fraction of praseodymium or a sum of cerium and praseodymium enclosed was 11.8 [mol %] or more.

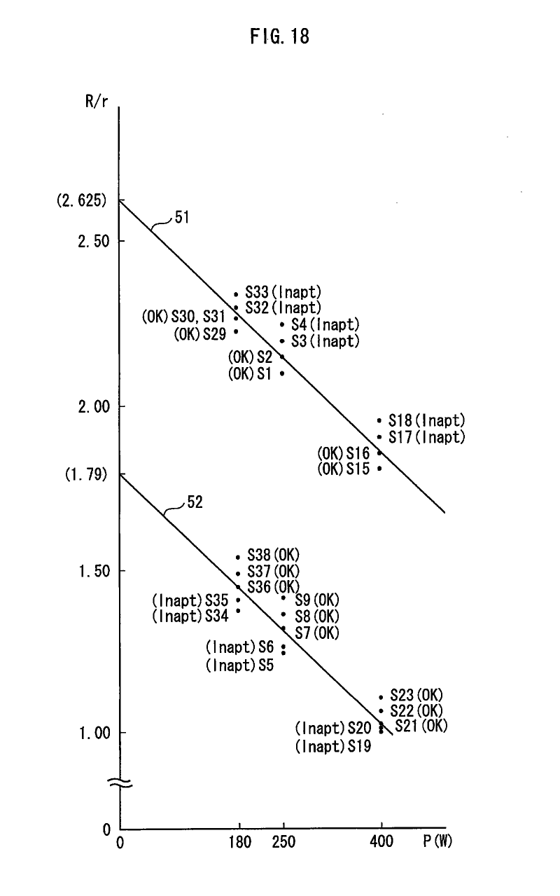

FIG. 18 shows a relationship between the power rating P and the dimensional rate R/r, which was obtained from the results of the above Experiments 1 to 3.

Horizontal and vertical axes of the graph shown in FIG. 18 indicate the power rating P and the dimensional rate R/r, respectively. Data of each sample whose luminous flux maintenance factor, total luminous flux and general color rendering index were measured in the above Experiments 1 to 3 is plotted in the graph (except for data obtained from the experiments in which a mole fraction of cerium enclosed was changed). “OK” is appended to data of each sample that received excellent evaluations as a result of the experiments. On the other hand, “Inapt” is appended to data of each sample that received poor evaluations as a result of the experiments.

Also, as shown in FIG. 18, an upper limit line 51 and a lower limit line 52 are drawn to separate data of “OK” samples from data of “Inapt” samples.

The upper limit line 51 can be expressed by the relationship R/r≦−0.0019P+2.625. The upper limit line 51 indicates an upper limit for a dimensional rate R/r that can suppress (i) an early reduction in the luminous flux maintenance factor, (ii) flicker and (iii) formation of cracks, in accordance with the power rating P.

The lower limit line 52 can be expressed by the relationship −0.0019P+1.79≦R/r. The lower limit line 52 indicates a lower limit for a dimensional rate R/r that can increase a total luminous flux and a general color rendering index as compared to conventional technology in accordance with the power rating P. Note that R/r>1.

In the above manner, the inventors have found an appropriate range for a dimensional rate R/r in accordance with the power rating P.

The first embodiment has explained a case where the sleeve 4 covers an entirety of the main tube portion 9 of the arc tube 3 and about half of each narrow tube portion 10. However, the sleeve 4 may surround at least a part of the discharge space 13 within the arc tube 3 that extends between the pair of electrodes 12. For instance, the same functional effects as those described above can be obtained also when the sleeve 4 surrounds only the entirety of the main tube portion 9, or surrounds an entirety of the enclosure 11.

By way of example, the first embodiment has described metal halide lamps 1 that each have a power rating of 180 [W], 250 [W] or 400 [W]. However, the present invention is not limited to being applied to such metal halide lamps that each have a power rating of 180 [W], 250 [W] or 400 [W]. Great functional effects can be obtained especially when the present invention is applied to a metal halide lamp having a power rating that is within a range of 180 [W] to 400 [W].

When the size of an arc tube in a high-wattage metal halide lamp (e.g., 400 [W] or more) and the size of an arc tube in a low-wattage metal halide lamp are reduced, the amount of increase in the tube wall loading of the former arc tube is greater than the amount of increase in the tube wall loading of the latter arc tube. As mentioned above, the flicker problem is more likely to occur when tube wall loading is increased. That is, in order to guarantee the life properties, it is necessary to lower the tube wall loading by making an arc tube large in size. However, when an arc tube is large in size, it is difficult to secure a predetermined level of vapor pressure; this may result in failure to achieve desired high luminous efficacy. On the other hand, in the present invention, the heat retaining effect of the sleeve makes it possible to increase the operating temperature of the arc tube, in spite of a low tube wall loading. Hence, the present invention can prevent flicker and achieve high luminous efficacy.

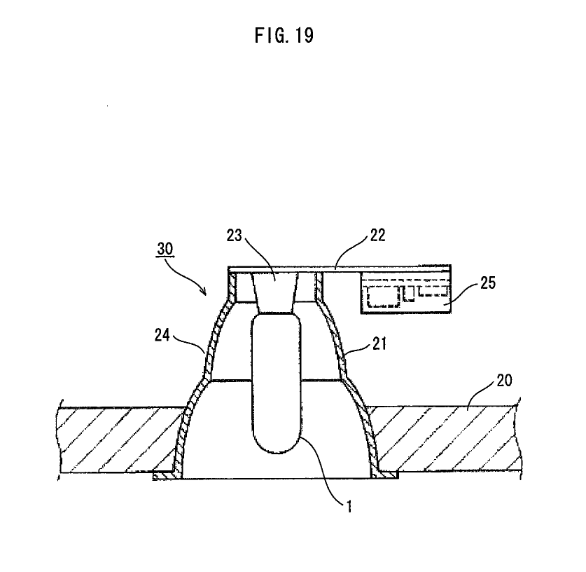

Described below is the second embodiment of the present invention. The second embodiment introduces a lighting device 30 that is, as shown in FIG. 19 used for ceiling lights and the like. The lighting device 30 is composed of a lighting device body (housing) 24, the metal halide lamp 1 pertaining to the first embodiment of the present invention, and a magnetic ballast 25. The lighting device body 24 includes (i) an umbrella-shaped reflective member 21 embedded in a ceiling 20, (ii) a plate-like base 22 mounted on the outer surface of the bottom of the reflective member 21, and (iii) a socket 23 joined to the inner surface of the bottom of the reflective member 21. The metal halide lamp 1 is attached to the socket 23 of the lighting device body 24. The magnetic ballast 25 is attached to the base 22 in a position that is distanced from the reflective member 21.

The power factor of the lighting device 30 during stable lighting is preferably 86[%] or more (the power factor=lamp power[W]/(lamp voltage[V]×lamp current[A]×100)).

Note that “stable lighting” denotes a state where a constant amount of electric power is supplied to the lighting device and a vapor pressure of a light emitting material within the arc tube is stable. Also note that the power factor is defined as a numerical value obtained by (i) first dividing the lamp power by the product of the lamp current and the lamp voltage, and then (ii) multiplying the result of the division by 100.

The shape and the like of the reflective member 21 may be determined in accordance with how and under what conditions the lighting device is used.

As set forth above, the lighting device 30 pertaining to the second embodiment uses the metal halide lamp 1 pertaining to the first embodiment. The lighting device 30 can therefore (i) achieve high luminous efficacy, (ii) prevent flicker in the illuminated surface of the arc tube, which is caused by the violent movement of the electric arc especially when the metal halide lamp 1 is lit while being tilted, (iii) prevent an early reduction in the luminous flux maintenance factor, and (iv) prevent formation of cracks in the enclosure of the arc tube.

Although it has been described in the present embodiment that the lighting device 30 is composed of the magnetic ballast 25, the lighting device 30 may be composed of an electronic ballast instead of the magnetic ballast 25.

Especially, by setting the power factor of the metal halide lamp 1 to 86[%] or more during stable lighting, it is possible to alleviate the load applied to the electric arc, and to suppress the violent movement of the electric arc to a greater extent. This can further prevent flicker in the illuminated surface of the arc tube, which is caused by the violent movement of the electric arc, and an early reduction in the luminous flux maintenance factor.

Based on the above Experiment 3 and with reference to FIG. 13A, the following describes the effects obtained by limiting the power factor to 86[%] or more.

Each of samples S29 to S31 was judged to have an excellent effect of preventing (i) an early reduction in the luminous flux maintenance factor, (ii) flicker, and (iii) cracks. As shown in FIG. 13A, samples S29, S30 and S31 had power factors of 87[%], 86[%] and 84[%], respectively.

As mentioned above, samples S30 and S31 had the same largest inner diameter D [mm], average value R [mm] and average value r [mm], but had different distances L [mm], tube wall loadings [W/cm²] and power factors [%]. Referring to the change in the luminous flux maintenance factor of sample S30, sample S30 had a luminous flux maintenance factor of 95[%] after 3000 hours of lighting and 90[%] after 18000 hours of lighting (the rated life thereof). On the other hand, referring to the change in the luminous flux maintenance factor of sample S31, sample S31 had a luminous flux maintenance factor of 91[%] after 3000 hours of lighting and 85[%] after 18000 hours of lighting.

Sample S29 had a luminous flux maintenance factor of 91[%] after 18000 hours of lighting, which exceeds 90[%]. As demonstrated above, by setting the power factor of a metal halide lamp in a lighting device to 86[%] or more, it is possible to maintain a high luminous flux maintenance factor (i.e., 90[%] or more) of the lamp within 18000 hours of lighting.

Note that in the above Experiment 3, the power factor of each sample was calculated after measuring the lamp voltage, lamp current and lamp power of each sample with use of a wattmeter during stable lighting (specifically, after 100 hours of lighting).

By way of example, the second embodiment has described that the lighting device is used for ceiling lights. However, the lighting device is not limited to a specific type of use. The lighting device may be used for outdoor lights, street lights, etc.

In the above embodiments, when the relationship R/r<−0.0019P+2.625 is satisfied, it is possible to prevent (i) flicker in the illuminated surface of the arc tube, which is caused by the violent movement of the electric arc, (ii) an early reduction in the luminous flux maintenance factor, and (iii) formation of cracks in the enclosure of the arc tube.

### INDUSTRIAL APPLICABILITY

The present invention provides a metal halide lamp and a lighting device using the same. In a case where at least one selected from the group consisting of cerium and praseodymium is enclosed in the metal halide lamp as a light emitting material, the metal halide lamp and the lighting device of the present invention can prevent flicker in an illuminated surface of an arc tube, which is caused by violent movement of an electric arc especially when the metal halide lamp is lit while being tilted. The technology of the present invention can be utilized when it is necessary to prevent a metal halide lamp and a lighting device using the same from having the following problems: an early reduction in a luminous flux maintenance factor, which is caused by scattering of materials constituting an enclosure of an arc tube; and formation of cracks in the enclosure of the arc tube.

### REFERENCE SIGNS LIST

1 metal halide lamp
2 outer tube
3 arc tube
4 sleeve
4a sleeve supporting member
5 base
6 frame
7 cylindrical portion
8 hemispherical portion
9 main tube portion
10 narrow tube portion
11 enclosure
12 electrode
13 discharge space
14 electrode bar
15 electrode coil
16 glass frit
17 electrode inductor
18 inner lead wire
19 outer lead wire
20 ceiling
21 reflective member
22 base
23 socket
24 lighting device body (housing)
25 magnetic ballast
30 lighting device
40 first sleeve portion
41 second sleeve portion
51 upper limit line
52 lower limit line

1. A metal halide lamp comprising:
an outer tube;
an arc tube that is arranged inside the outer tube and includes (i) an enclosure made of translucent ceramic and (ii) a pair of electrodes arranged inside the enclosure; and
a sleeve that is arranged inside the outer tube and outside the arc tube so as to surround at least a part of a discharge space in the arc tube, the part of the discharge space extending between the pair of electrodes, wherein
a light emitting material that includes at least one selected from the group consisting of cerium (Ce) and praseodymium (Pr) is enclosed in the enclosure,
a relationship 0.7<L/D<3 is satisfied, with L denoting a distance [mm] between the electrodes and D denoting a largest inner diameter [mm] of a part of the arc tube surrounding the part of the discharge space, and
a relationship R/r≦−0.0019P+2.625 is satisfied (where R/r>1), with R denoting an average inner diameter [mm] of a part of the sleeve surrounding the part of the discharge space, r denoting an average outer diameter [mm] of the part of the arc tube, and P denoting a lamp power rating [W].

2. The metal halide lamp of claim 1, wherein
the following relationship is further satisfied:
−0.0019P+1.79≦R/r.

3. The metal halide lamp of claim 2, wherein
in addition to the at least one selected from the group consisting of cerium and praseodymium, the light emitting material further includes one or more materials other than cerium and praseodymium, and
a mole fraction of a sum of cerium and praseodymium in the light emitting material excluding mercury is 11.8 [mol %] or more.

4. The metal halide lamp of claim 3, wherein
the mole fraction of the sum of cerium and praseodymium in the light emitting material excluding mercury is 15.0 [mol %] or less.

5. The metal halide lamp of claim 1, wherein
the enclosure of the arc tube includes a main tube portion having the discharge space therein and narrow tube portions connected to respective ends of the main tube portion, and
the sleeve surrounds an entirety of the main tube portion and at least a part of each narrow tube portion.

6. The metal halide lamp of claim 1, wherein
the sleeve has a double-layer structure and includes a first cylindrical portion and a second cylindrical portion, the first cylindrical portion being inserted through the second cylindrical portion with a space therebetween.

7. The metal halide lamp of claim 1, wherein
the following relationship is further satisfied:
10 [mm]≦R<50 [mm].

8. The metal halide lamp of claim 7, wherein
the following relationship is further satisfied:
0.5 [mm]≦a thickness of the sleeve≦9.0 [mm].

9. The metal halide lamp of claim 1, wherein
the outer tube is an evacuated vacuum tube.

10. The metal halide lamp of claim 1, wherein
a nitrogen gas is enclosed in the outer tube, and
when a temperature of the nitrogen gas is 300 [K], an inner pressure of the outer tube is in a range of 40 [kPa] to 80 [kPa] inclusive.

11. A lighting device comprising:
a housing to which a lamp socket is joined;
the metal halide lamp of claim 1, which is attached to the lamp socket; and
a ballast for lighting the metal halide lamp.

12. The lighting device of claim 11, wherein
the ballast is a magnetic ballast.

13. The lighting device of claim 12, wherein
a lamp power factor during stable lighting is 86[%] or more.
